(19) United States
(12) Patent Application Publication
(10) Pub. No.: US 2025/0192892 A1
(43) Pub. Date: Jun. 12, 2025

(54) DSP-FREE COHERENT OPTICAL LINKS

(71) Applicant: Enosemi, Inc., Sacramento, CA (US)

(72) Inventors: Matthew Streshinsky, Taos, NM (US); Ari Novack, Seattle, WA (US); Shahab Ardalan, San Jose, CA (US)

(21) Appl. No.: 18/953,716

(22) Filed: Nov. 20, 2024

Related U.S. Application Data
(60) Provisional application No. 63/608,238, filed on Dec. 9, 2023.

(51) Int. Cl. H04B 10/50; H04B 10/67; H04B 10/69

(52) U.S. Cl. CPC H04B 10/506; H04B 10/503; H04B 10/67; H04B 10/69

(57) ABSTRACT

Optical links can solve the bottleneck in communication between memory chips and ASICS by providing bandwidth densities that can exceed the 800 Gbps/mm short-reach electrical shoreline density. For example, an optical link includes a local transmitter, optically coupled to a remote receiver via one or more optical fibers. A light source generates a plurality of optical wavelength channels, and a plurality of modulators generate a plurality of modulated optical channel signals. The remote receiver includes a demultiplexer for routing each channel to photodetectors, and an electrical amplifier for summing the squares of the cosine and sine terms from the output from the hybrid, which is linearly proportional to the amplitude of the modulated optical wavelength channels, but with the added benefit of a gain from the local oscillator signal.

### TECHNICAL FIELD

The present disclosure relates to an optical link for high-bandwidth transmission between integrated circuits, and in particular to a dispersion-free coherent optical link.

### BACKGROUND

Modern AI computer systems are bottlenecked by GPU-to-memory bandwidth. This problem is compounded as the distances between chips increases because the achievable bandwidth density decreases. High-bandwidth memory (HBM) is typically placed close to compute application specific integrated circuits (ASICs) because the achievable bandwidth density of the latest-generation HBM achieves more than 800 Gbps/mm of bandwidth per chip edge shoreline. Unfortunately, the HBM electrical links can only reach a few millimeters. For farther reaches, and to access significantly higher quantities of memory, longer-reach electrical interfaces are limited to 400 Gbps/mm of shoreline density. A compute chip will tradeoff the quantity of memory that can be accessed with the total bandwidth to memory. The resulting bottleneck means the highest-bandwidth links are only available to a small amount of total memory due to physical limitations.

Optical links can solve the bottleneck by providing bandwidth densities that can exceed the 800 Gbps/mm short-reach electrical shoreline density while providing hundreds of meters of reach. For example, an optical link includes a local transmitter, optically coupled to a remote receiver via one or more optical fibers. A light source generates a plurality of optical wavelength channels, and a plurality of modulators generate a plurality of modulated optical channel signals. The remote receiver includes a demultiplexer for routing each channel to photodetectors. The optical links can achieve extremely high bandwidth densities, with up to 32 wavelength channels.

The drawback to this optical link architecture is that it is limited by receiver sensitivity and does not efficiently scale to a large number of wavelength channels, even with relatively optimistic insertion loss assumptions.

An object of the present disclosure is to provide an optical link between integrated circuit chips, e.g. memory or ASIC, with improved receiver sensitivity and a large bandwidth-density.

### SUMMARY

Accordingly, a first apparatus includes an optical link comprising:
a local transmitter configured for generating a plurality of modulated optical wavelength channels (25), comprising:
one or more light sources configured for generating a plurality of input optical signals (10) with different wavelength channels;
a plurality of modulators for modulating the plurality of input optical signals forming the plurality of modulated optical wavelength channels (25);
one or more first splitters for generating first local oscillator signals from the plurality of input optical signals;
one or more multiplexers disposed before or after the plurality of modulators, which in combination with the plurality of modulators is configured for generating a plurality of modulated multi-wavelength optical signals (18), each with a respective subset of the plurality of modulated optical wavelength channels (25);
a remote receiver, comprising:
a plurality of demultiplexers, each demultiplexer configured for demultiplexing one of the plurality of modulated multi-wavelength optical signals (18) into the respective subset of the plurality of modulated optical wavelength channels (25);
a plurality of optical hybrid mixers, each optical hybrid mixer configured for mixing one of second local oscillator signals from a remote transmitter with one of the plurality of modulated optical wavelength channels (25) producing mixed optical signals ((I+ and I−) and (Q+ and Q−) or (I1, I2 and I3));
a plurality of photodetectors for converting the mixed optical signals into electrical signals; and
an amplifier configured for summing squares ((I++I−)²+(Q++Q−)² or (I1², I2² and I3²)) of the electrical signals.

In any of the aforementioned embodiments the receiver may be configured for cancelling frequency and phase differences between the second local oscillator signals and the plurality of modulated optical wavelength channels and/or suppressing interference from adjacent wavelength channels.

In any of the aforementioned embodiments the receiver may include analog circuitry with an analog optical-to-electrical bandwidth greater than a bandwidth of each optical wavelength channel but smaller than an optical frequency spacing between adjacent modulated optical wavelength channels, whereby the receiver only transmits the electrical signals that correspond to the modulated optical wavelength channels with a wavelength closest to a wavelength of the second local oscillator signals.

In any of the aforementioned embodiments the one or more multiplexers may be disposed before the plurality of modulators for combining the plurality of input optical signals into a combined laser signal;
further comprising a second splitter for splitting the combined laser signal into a plurality of multi-wavelength signal portions; and
wherein the plurality of modulators may comprise a plurality of sets of wavelength-dependent modulators, each one of the plurality of sets of wavelength-dependent modulators is configured for modulating a respective one of the plurality of multi-wavelength signal portions generating the respective subset of the plurality of modulated optical wavelength channels (25) and the respective one of the plurality of modulated multi-wavelength optical signals (18).

In any of the aforementioned embodiments the one or more first splitters may comprise a plurality of LO splitters (233), each of the plurality of LO splitters (233) configured for splitting a respective one of the input optical signals into a plurality (2M) of optical signal portions, a first half of the plurality of optical signal portions forming the first local oscillator signals, and a second half of the plurality of optical signal portions transmitted to the plurality of modulators; and
wherein each one of the plurality of modulators may receive one of the second half of the plurality of optical signal portions for generating a corresponding one of the plurality of modulated optical wavelength channels (25);
wherein the one or more multiplexers may comprises a plurality of multiplexers (213), one of the plurality of multiplexers corresponding to each one of the plurality of LO splitters (233) configured for combining the respective subset of the plurality of modulated optical wavelength channels (25) into a respective one of the plurality of multi-wavelength optical signals (18).

In any of the aforementioned embodiments the local transmitter further comprises an interleaver configured for combining the plurality of modulated multi-wavelength optical signals onto a single optical fiber; and
wherein the remote receiver may further comprise a deinterleaver configured for separating the modulated multi-wavelength optical signals onto different waveguides for transmission to a different one of the plurality of demultiplexer.

In any of the aforementioned embodiments the one or more first splitters may comprise a plurality of first splitters, each one of the plurality of first splitters coupled between the light source and the multiplexer.

In any of the aforementioned embodiments the one or more first splitters may comprise a first splitter coupled between the second splitter and the plurality of modulators.

In any of the aforementioned embodiments the plurality of modulators may comprise a plurality of wavelength dependent modulators.

In any of the aforementioned embodiments the plurality of demultiplexers may comprise a plurality of wavelength dependent optical filters.

In any of the aforementioned embodiments each one of the plurality of optical hybrid mixers may comprise a 90° optical hybrid mixer configured for mixing one of the second local oscillator signals with one of the modulated optical wavelength channels producing in-phase (I+ and I−) and quadrature (Q+ and Q−) electrical signals; and
wherein the amplifier may be configured for summing squares ((I++I−)²+(Q++Q−)²) of the in-phase and quadrature electrical signals.

In any of the aforementioned embodiments the remote receiver may also comprise one or more polarization splitters configured for splitting each of the plurality of modulated multi-wavelength optical signals (18) into a respective first orthogonally polarized receiver signal portion and a respective second orthogonally polarized receiver signal portion;
wherein the plurality of demultiplexers may comprise a plurality of first demultiplexers configured for demultiplexing the respective first orthogonally polarized receiver signal portion into first polarized portions of the plurality of modulated optical wavelength channels, and a plurality of second demultiplexers configured for demultiplexing the respective second orthogonally polarized receiver signal portions into second polarized portions of the plurality of modulated optical wavelength channels;
wherein each one of the plurality of optical hybrid mixers may comprise a 120° optical hybrid mixer configured for receiving one of the first polarized portions of the plurality of modulated optical wavelength channels, one of the second polarized portions of the plurality of modulated optical wavelength channels, and one of the second local oscillator signals generating a first photodetector current, a second photodetector current, and a third photodetector current; and
wherein each 120° optical hybrid mixer may be configured for adding the squares of first photodetector current, second photodetector current and third photodetector current.

According to a second apparatus an optical device comprises:
a local transmitter configured for generating a first plurality of modulated optical wavelength channels (25), comprising:
one or more light sources configured for generating a first plurality of input optical signals (10) with different wavelength channels;
a plurality of modulators for modulating the first plurality of input optical signals (10) forming the first plurality of modulated optical wavelength channels (25);
one or more first splitters for generating first local oscillator signals from the first plurality of input optical signals; and
one or more multiplexers disposed before or after the plurality of modulators, which in combination with the plurality of modulators is configured for generating a first plurality of modulated multi-wavelength optical signals (18), each with a respective subset of the first plurality of modulated optical wavelength channels (25); and
a local receiver, comprising:
a plurality of demultiplexers, each demultiplexer configured for demultiplexing one of a second plurality of modulated multi-wavelength optical signals (18) from a remote transmitter into a respective subset of a second plurality of modulated optical wavelength channels (25);
a plurality of optical hybrid mixers, each optical hybrid mixer configured for mixing one of the first local oscillator signals with one of the second plurality of modulated optical wavelength channels producing mixed optical signals ((I+ and I−) and (Q+ and Q−) or I1, I2 and I3);
a plurality of photodetectors for converting the mixed optical signals into electrical signals; and
an amplifier configured for summing squares ((I++I−)²+(Q++Q−)² or (I₁², I₂² and I₃²)) of the electrical signals.

In any of the aforementioned embodiments the local receiver may be configured for cancelling frequency and phase differences between the first local oscillator signals and the second plurality of modulated optical wavelength channels and/or suppressing interference from adjacent wavelength channels.

In any of the aforementioned embodiments the local receiver may include analog circuitry with an analog optical-to-electrical bandwidth greater than a bandwidth of each of the second plurality of modulated optical wavelength channels but smaller than an optical frequency spacing between adjacent ones of the second plurality of modulated optical wavelength channels, whereby the local receiver transmits only electrical signals that correspond to the second modulated optical wavelength channels with a wavelength closest to a wavelength of the first local oscillator signals.

In any of the aforementioned embodiments the one or more multiplexers may be disposed before the plurality of modulators for combining the first plurality of input optical signals into a combined laser signal;
further comprising a second splitter for splitting the combined laser signal into a plurality of multi-wavelength signal portions; and
wherein the plurality of modulators may comprise a plurality of sets of wavelength-dependent modulators, each one of the plurality of sets of wavelength-dependent modulators is configured for modulating a respective one of the plurality of multi-wavelength signal portions generating the respective subset of the plurality of modulated optical wavelength channels (25) and the respective one of the first plurality of modulated multi-wavelength optical signals (18).

In any of the aforementioned embodiments the one or more first splitters may comprise a plurality of first splitters, each one of the plurality of first splitters coupled between the light source and the multiplexer.

In any of the aforementioned embodiments the plurality of modulators may comprise a plurality of wavelength dependent modulators; and wherein the plurality of demultiplexers may comprises a plurality of wavelength dependent optical filters.

In any of the aforementioned embodiments each one of the plurality of optical hybrid mixers may comprise a 90° optical hybrid mixer configured for mixing one of the second local oscillator signals with one of the modulated optical wavelength channels producing in-phase (I+ and I−) and quadrature (Q+ and Q−) electrical signals; and
wherein the amplifier may be is configured for summing squares ((I++I−)²+(Q++Q−)²⁾ of the in-phase and quadrature electrical signals.

In any of the aforementioned embodiments the local receiver may include one or more polarization splitters configured for splitting each of the second plurality of modulated multi-wavelength optical signals (18) into a respective first orthogonally polarized receiver signal portion and a respective second orthogonally polarized receiver signal portion;
wherein the plurality of demultiplexers may comprise a plurality of first demultiplexers configured for demultiplexing the respective first orthogonally polarized receiver signal portion into first polarized portions of the second plurality of modulated optical wavelength channels, and a plurality of second demultiplexers configured for demultiplexing the respective second orthogonally polarized receiver signal portions into second polarized portions of the second plurality of modulated optical wavelength channels;
wherein each one of the plurality of optical hybrid mixers may comprise a 120° optical hybrid mixer configured for receiving one of the first polarized portions of the second plurality of modulated optical wavelength channels, one of the second polarized portions of the second plurality of modulated optical wavelength channels, and one of the second local oscillator signals generating a first photodetector current, a second photodetector current, and a third photodetector current; and
wherein each 120° optical hybrid mixer is configured for adding the squares of first photodetector current, second photodetector current and third photodetector current.

### BRIEF DESCRIPTION OF THE DRAWINGS

Some example embodiments will be described in greater detail with reference to the accompanying drawings, wherein:

FIG. 1 is a schematic diagram of an optical link in accordance with an example of the present disclosure, illustrating a local transmitter and a local receiver;

FIG. 2 is a schematic diagram of an optical hybrid mixer and electrical amplifier in accordance with an example of the present disclosure;

FIG. 3 is a schematic diagram of an optical link in accordance with an example of the present disclosure, illustrating a local transmitter and a local receiver;

FIG. 4 is a schematic diagram of a polarization-independent optical link in accordance with an example of the present disclosure with a 120° hybrid optical mixer, illustrating a local transmitter and a local receiver;

FIG. 5 is a schematic diagram of an optical link in accordance with an example of the present disclosure, illustrating a local transmitter and a local receiver;

FIG. 6 is a schematic diagram of a polarization independent optical link in accordance with an example of the present disclosure, with a 120° hybrid optical mixer, illustrating a local transmitter and a local receiver;

FIG. 7 is a schematic diagram of a polarization-independent optical link in accordance with an example of the present disclosure, with two 90° hybrid optical mixers, illustrating a local transmitter and a local receiver; and

FIG. 8 is a schematic diagram of an optical link in accordance with an example of the present disclosure, illustrating a local transmitter and a local receiver.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art.

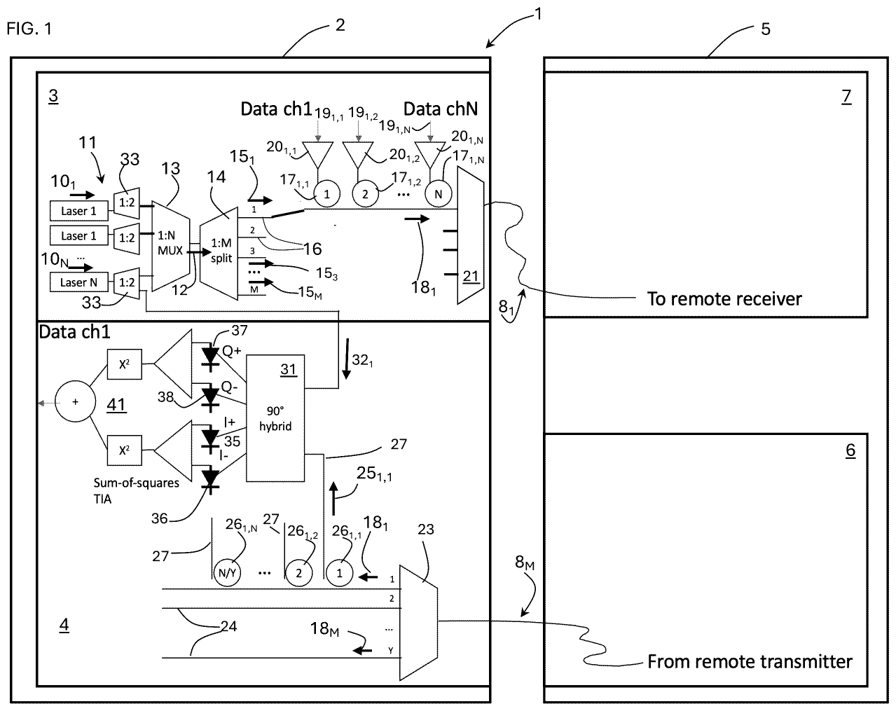

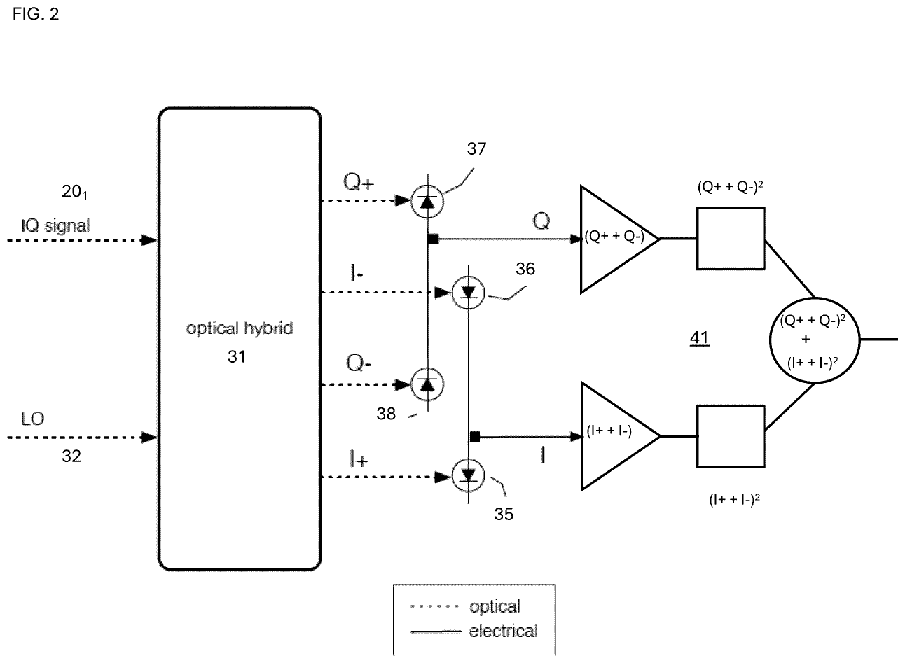

According to a first example embodiment, illustrated in FIGS. 1-2, an optical link 1 includes a local transmitter/receiver device 2 comprising a local transmitter 3 and a local receiver 4, and a remote transmitter/receiver 5 comprising a remote transmitter 6, the same as the local transmitter 3, and a remote receiver 7, the same as the local receiver 4. The local transmitter/receiver device 2 is optically coupled to the remote transmitter/receiver 5 via one or more optical fiber 8. The local transmitter 3 and the remote transmitter 6 each include a light source 11, comprised of a plurality of lasers or a multi-wavelength laser for generating a plurality (N) of optical wavelength channels 10₁ to 10_{N} each with a different optical wavelength. The plurality of optical wavelength channels 10₁ to 10_{N} are combined into combined laser signal 12 with the plurality of different optical wavelength channels with a multiplexer 13. A splitter 14 with one input and a plurality (M) of outputs is optically coupled to the output of the multiplexer 13, and is configured to split the combined laser signal 12 into a plurality (M) of different multi-wavelength signals 15₁ to 15_{M}, each with all of the plurality (N) of different wavelength channels. Each of the multi-wavelength signals 15₁ to 15_{M} is output one of the plurality (M) of outputs of the splitter 14, and is input to one of a plurality (M) bus waveguides 16, each of the plurality of bus waveguides 16 is connected with a plurality of sets of wavelength dependent modulators 17_{1,1} to 17_{M,N}, one modulator 17 per wavelength in each of the multi-wavelength signals 15₁ to 15_{M}, generating a plurality of subsets of modulated multi-wavelength optical signals 18₁ to 18_{M}, i.e. one for each multi-wavelength signal 15₁ to 15_{M}. Each multi-wavelength optical signal 18₁ to 18_{M} comprising a plurality of modulated optical wavelength channels 25_{1,1} to 25_{M,N}. An optional optical interleaver 21 may be provided in some embodiments, which is configured to combine the plurality of modulated multi-wavelength optical signals 18₁ to 18_{M} for transmission on the one or more optical fibers 8. Alternatively, a plurality of optical fibers 8₁ to 8_{M} can be configured to transmit a respective one of the modulated multi-wavelength optical signals 18₁ to 18_{M} between the local transmitter/receiver device 2 and the remote transmitter/receiver 5. Each modulator 17_{1,1} to 17_{M,N} may comprises a silicon micro-ring modulator driven with a respective one of a plurality of electrical modulation signals 19_{1,1} to 19_{M,N} by a corresponding one of a plurality of drivers 20_{1,1} to 20_{M,N}.

In some of the embodiments, each of the local receiver 4 and the remote receiver 7 may include a deinterleaver 23 for separating the plurality of multi-wavelength optical signals 18₁ to 18_{M} onto a plurality of different receiver bus waveguides 24. Each receiver 4 and 7 comprises a demultiplexer, which in the illustrated example embodiment comprises a plurality of wavelength-dependent optical filters 26_{1,1} to 26_{M,N}, one for each optical wavelength in the multi-wavelength optical signal 18₁ to 18_{M}, are coupled to each receiver bus waveguides 24 configured for separating (demultiplexing) each of the plurality of modulated optical wavelength channels 25_{1,1} to 25_{M,N} in each of the plurality of multi-wavelength optical signals 18₁ to 18_{M} from each other and onto a respective optical waveguide 27.

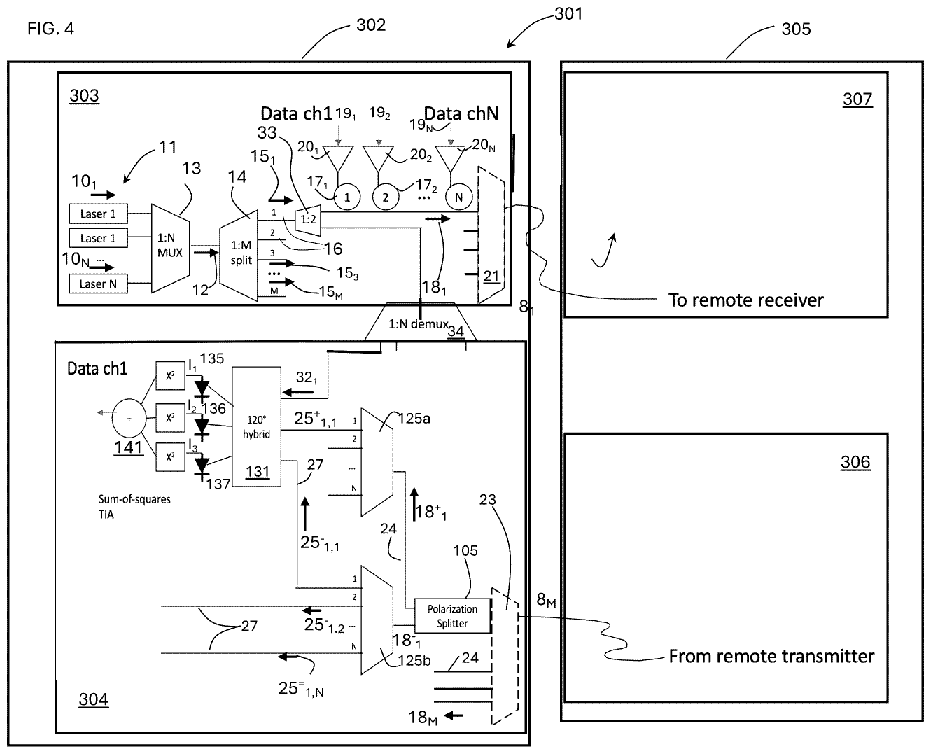

Each optical waveguide 27 from each bus waveguide 24 is optically coupled to one of a plurality of 90° optical hybrid mixers 31 (only one shown). The multi-wavelength laser source 11 is also used as a local oscillator (LO) signal generator for generating a local oscillator (LO) signal 32₁ to 32_{N} that is transmitted to each optical hybrid mixer 31 to be coherently mixed with an incoming RX signal, i.e. one of the modulated optical wavelength channels 25_{1,1} to 25_{M,N}. Each LO signal 32₁ to 32_{N} and each corresponding RX signal, e.g. the modulated optical wavelength channels 25_{1,1} to 25_{,N} will be on different, but closely-spaced wavelengths and will produce an intradyne beat-signal after mixing in the 90° optical hybrid mixer 31 that produces In-phase (I+ and I−) and Quadrature (Q+ and Q−) signals, see FIG. 2, (or a 120° optical hybrid mixer that produces three outputs, see FIG. 4).

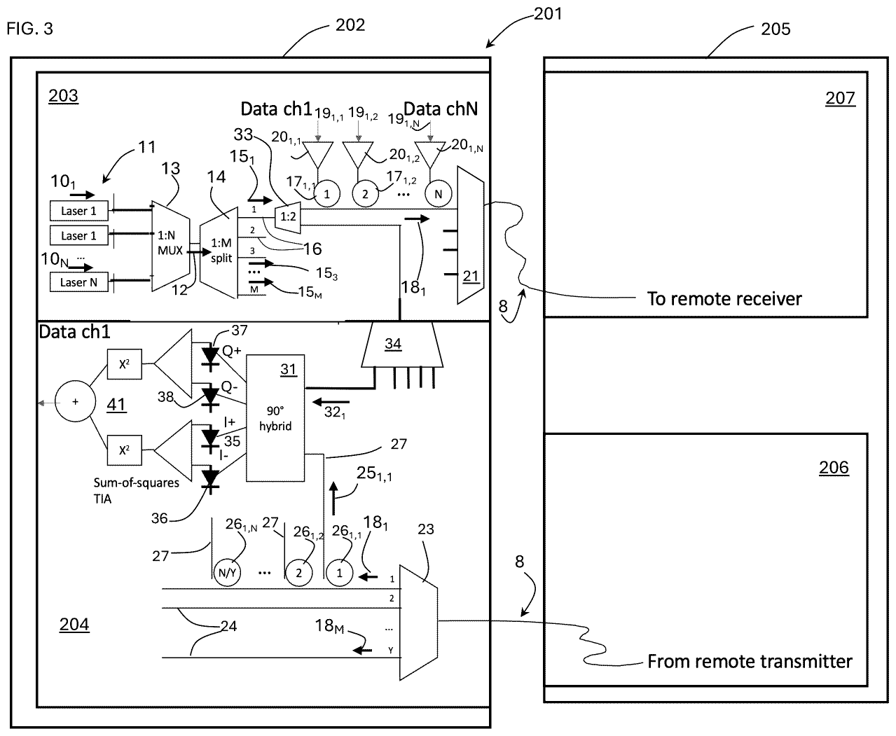

The LO signals 32₁ to 32_{N} can be tapped from the local transmitter 3 and the remote transmitter 6 utilizing one or more LO splitters 33, which can be disposed at various locations in the local transmitter 3 and the remote transmitter 6, such as after each laser or the multi-wavelength laser in the light source 11, each LO splitter 33 may tap off one of the plurality (N) of optical wavelength channels 10₁ to 10_{N}, as in FIG. 1. Alternatively, the LO splitter 33 may be disposed in one of the bus waveguides 16 after the splitter 14, as in FIG. 3, configured for tapping off one of the multi-wavelength signals, e.g. 15₁, comprising all of the optical wavelength channels 10₁ to 10_{N} for demultiplexing in the receiver 4 or 7.

For the example embodiment of FIG. 3, an optical link 201 includes a local transmitter/receiver 202 comprising a local transmitter 203 and a local receiver 204, and a remote transmitter/receiver 205 comprising a remote transmitter 206 and a remote receiver 207, all of which include similar elements to the aforementioned optical link 1, as designated by like reference numerals. However, a LO splitter 33 is provided in the local transmitter 203 and the remote transmitter 206, and a demultiplexer 34 is provided in the local receiver 204 and the remote receiver 207 to demultiplex the portions of the multi-wavelength signal 15₁, into the plurality (N) of optical wavelength channels 10₁ to 10_{N}, for transmission as LO signals 32₁ to 32_{N} to the corresponding 90° optical hybrid mixers 31. In the example embodiment of FIG. 3, only a single LO splitter 33 is required per N optical channels, since the tapped multi-wavelength signal 15₁ includes the plurality (N) of optical wavelength channels 10₁ to 10_{N}.

A complex electrical amplifier 41, such as a transimpedance amplifier (TIA), is configured to perform a sum-of-squares operation. The desired output of the amplifier 41 is to sum the squares of the sum of the in-phase signals and the sum of the quadrature signals, i.e. (I++I−)²+(Q++Q−)². Accordingly, the output channels of the optical hybrid mixer 31 produce an electrical output that contains no LO-RX beat frequency. In this way, the coherent optical link 1, 201, etc. is free of digital signal processors (“DSP-free”) since the novel nonlinear electrical amplifiers 41 in the local receivers 4 and 204, et al and the remote receivers and 7 and 207, et al are performing DSP functionality in the analog domain.

The link architecture enables an order-of-magnitude improvement in receiver sensitivity and bandwidth-density. Reserving some fraction of optical power that does not need to couple to a fiber, route through an optical network, and couple into another chip results in efficient & high-yield optical gain as well as excellent wavelength selectivity through coherent intradyne mixing.

In some embodiments, a 90° hybrid optical mixer 31 is used, in which each of the four outputs is connected to a respective photodetector: I+ photodetector 35, I− photodetector 36, Q+ photodetector 367 and Q− photodetector 38 for converting the plurality of modulated optical wavelength channels 25 to electrical signals. The I+ photodetector 35 and I− photodetector 36 currents are summed, as are the Q+ photodetector 37 and Q− photodetector 38 currents. The AC photocurrent generated by a mixing process in the 90° optical hybrid mixer 31 with the balanced photodetector pairs of photodetectors 34 and 35, and 36 and 37 and sinusoidal waveforms is approximately:

$$I ++ I - : {I}_{ppd} = 8 \sqrt{{I}_{LO} {I}_{RX}} cos ( Δω ( t ) + Δϕ ( t ) ) ; and$$

$$Q ++ Q - : {I}_{ppd} = 8 \sqrt{{I}_{LO} {I}_{RX}} sin ( Δω ( t ) + Δϕ ( t ) ) ;$$

Where I_{LO} and I_{RX} are the RMS instantaneous DC photocurrent outputs of the RX signal, e.g. the modulated optical wavelength channels 25_{1,1} to 25_{M,N}, and the LO signal 32₁ to 32_{N} from the photodetector pairs 35/36 and 37/38, and Δω(t) and Δϕ(t) are the time-varying frequency and phase differences in the LO and RX optical frequencies and phases. For amplitude modulation, I_{RX} will vary with time and so the output amplitude will be proportional to the square root amplitude of the RX signal, e.g. the modulated optical wavelength channels 25_{1,1} to 25_{N,M}. One interesting phenomenon is that the sum of the squares of the cosine and sine terms from the output from the 90° hybrid mixer 31 should be linearly proportional to the amplitude of the RX signal, e.g. the modulated optical wavelength channels 25_{1,1} to 25_{N,M}, like in a direct detect receiver, but with the added benefit of a multiplicative gain from the local oscillator signal 32₁ to 32_{N}. In this way, the frequency and phase differences between the LO signal 32₁ to 32_{N} and the RX signal, e.g. the modulated optical wavelength channels 25_{1,1} to 25_{N,M}, can be effectively canceled with appropriate analog circuitry provided in the receivers 4, 7, 204, 207, etc. by selecting appropriate analog electrical bandwidths from input to output corresponding to the difference in optical wavelengths in wavelength channels 25_{1,1} to 25_{N,M}. As will be shown below, the mixing products of the LO signal 32₁ to 32_{N} and the RX signal that result through the input of an optical mixer, such as a 90° hybrid mixer 31 or a 120° hybrid mixer 131, followed by photodetectors 35-38 or 135-137, create an electrical signal with a total bandwidth corresponding to the total bandwidth of the RX signal. The mixing products that results from the RX signal channel closest in optical wavelength to the LO wavelength will have the lowest electrical frequency, while the mixing products from all other RX signal channels and the LO wavelength will have higher electrical frequencies. By choosing the analog optical-to-electrical bandwidth of the analog circuitry in the receiver 2, 4, 102, 104 etc. appropriately, such as greater than the bandwidth of the RX signal but smaller than the optical frequency spacing between adjacent RX signal channels, the analog circuitry will effectively transmit only the electrical signal that corresponds to the RX signal with wavelength closest to the LO wavelength. The analog optical-to-electrical bandwidth of the receiver 2, 4, 102, 104 etc. is typically determined by the overall transfer function of the components within it: the optical transmission of the optical components, where present, e.g. the optical fibers 8, the polarization splitter 105, the deinterleavers 125, the filters 26, the photodetectors 35 to 38 and 135 to 137, the electrical amplifier 41, and any other electrical components that may follow the electrical interconnects following the output of the receiver 2, 4, 102, 104 etc. In practice, it is typical that the optical components have very wide bandwidths and that the dominant limitation on optical-to-electrical bandwidth will be principally determined by the electrical bandwidth of the electrical amplifier 41.

The sum of the squares of the 90° hybrid outputs are: (I++I−)²+(Q++Q−)²=64 I_{LO}I_{RX}(COS²(Δω(t)+Δϕ(t))+sin²(Δω(t)+Δϕ(t)))

Which then simplifies to: (I++I−)²+(Q++Q−)²=64 I_{LO}I_{RX}.

In another example embodiment, illustrated in FIG. 4, a polarization-independent optical link 301 includes a local transmitter/receiver 302 comprising a local transmitter 303 and a local receiver 304, and a remote transmitter/receiver 305 comprising a remote transmitter 306 and a remote receiver 307, all of which include similar elements to the aforementioned optical link 1 and 201 as designated by like reference numerals. The local transmitter 303 can be identical to the local transmitter 3 or the local transmitter 203. The local receiver 304 and the remote receiver 307, include a polarization splitter 105 for splitting each of the plurality of multi-wavelength optical signals 18₁ to 18_{M} into orthogonal polarization portions, i.e. a first polarized demulti-wavelength optical signal portion 18⁻₁, for transmission to a first demultiplexer 125a, and a second polarized multi-wavelength optical signal portion 18⁺₁ for transmission to a second demultiplexer 125b. The second polarized multi-wavelength optical signal portion 18⁻₁ is orthogonally polarized to the first polarized multi-wavelength optical signal portion 18⁺₁. The first demultiplexer 125a and the second demultiplexer 125b can each comprise a plurality of wavelength-dependent optical filters 26_{1,1} to 26_{M,N}, one for each optical wavelength in the multi-wavelength signal 18₁ to 18_{M}, as in receiver 4 and 204. The first demultiplexer 125a and the second demultiplexer 125b can each comprise any other suitable demultiplexer, as is known in the art.

Each first demultiplexer 125a separates the first polarized multi-wavelength optical signal portion 18⁻₁ into separate signals, each comprising a first polarized portion of a respective one of the modulated optical wavelength channels, e.g. 25⁻_{1,1} to 25⁻_{1.N}, and each second demultiplexer 125b separates the second polarized multi-wavelength optical signal 18⁺₁ into separate signals, each comprising a second polarized portion of a respective one of the modulated optical wavelength channels, e.g. 25⁺_{1,1} to 25⁺_{1,N} Each of the first and second demultiplexers 125a and 125b includes a plurality of outputs (N), one for each of polarized portion of the modulated optical wavelength channels 25_{1,1} to 25_{1,N}. Each of the plurality of outputs of the demultiplexers 125a and 125b is coupled to a respective 120° hybrid optical mixer 131, whereby each 120° hybrid optical mixer 131 receives the first and second polarized portions of a respective modulated optical wavelength channel 25_{1,1} to 25_{M,N} along with a LO signal 34₁ to 34_{N}. The advantage of the 120° optical hybrid mixer 131 is that it enables a polarization-independent data signals incident on the local receiver 304 and the remote receiver 307.

The 120° hybrid optical mixer 131 has three outputs, each connected to a respective photodetector 135, 136 and 137, generating photocurrents I₁, I₂, and I₃, respectively. The AC photocurrents I₁, I₂, and I₃, generated by a mixing process in the 120° optical hybrid mixer 131 are calculated below, where rⱼ(t) is the amplitude of the j^{th} channel (in a WDM configuration with j channels):

$${I}_{i} = \frac{2}{3} {RE}_{LO} [ {\sum }_{j = 1}^{3} {r}_{j} ( t ) cos φcos ( 2 πΔ {v}_{j} t - \frac{2}{3} i π + \frac{4}{3} π ) + {\sum }_{j = 1}^{3} {r}_{j} ( t ) sin φcos ( 2 πΔ {v}_{j} t + \frac{2}{3} i π - \frac{2}{3} π ) ] i = 1 , 2 , 3$$

Similar to the 120° hybrid case, the sum of the squares of the photodetector currents I₁, I₂, and I₃, from photodetectors 135, 136, and 137, respectively, are below: (where f₂²(t) is the intensity one of the modulated optical wavelength channels 25_{1,1} to 25_{M,N}, f_{offset} is the frequency offset between the RX signal, e.g. the modulated optical wavelength channels 25_{1,1} to 25_{M,N} and the corresponding LO signal 32₁ to 32_{N}:

$$S ( t ) = {I}_{1}^{2} + {I}_{2}^{2} + {I}_{3}^{2} = \frac{2}{3} {R}^{2} {E}_{LO}^{2} [ {r}_{2}^{2} ( t ) - {r}_{2}^{2} ( t ) sin φsin ( 4 π {f}_{offset} t + ψ + \frac{π}{6} ) + {r}_{1}^{2} ( t ) + {r}_{3}^{2} ( t ) + 2 {r}_{1} ( t ) {r}_{3} ( t ) cos ( 4 π {f}_{offset} t ) ]$$

In the case of the 120° hybrid mixer 131, it can be shown that if the frequency offset between the LO signal 32₁ to 32_{N} and the RX signal, e.g. the modulated optical wavelength channels 25_{1,1} to 25_{M,N} is greater than the optical-to-electrical bandwidth of the photodetectors 135, 136 and 137, and the electrical amplifier (TIA) 141, then the spurious term r²₁(t)sin ϕ sin(4πf_{offset}(t)+ψ+π/6) can be suppressed, along with interference from adjacent wavelength channels r²₁(t)+r²₃(t)+2r₁(t)r₃(t)cos(4γf_{offset}(t)) using suitable circuitry provided in the electrical amplifier (TIA) 141. The “cancellation” in the circuitry is a result of the finite optical-to-electrical bandwidth of the receiver electronics. For example, the terms cos(Δω(t)) (as above) and cos(4πf_{offset}) will produce frequencies above the optical-to-electrical bandwidth of the receiver, e.g. receivers 4, 7, 104, 107, 204, 207 etc, and will thus be attenuated, assuming that the receiver optical-to-electrical bandwidth is less than the channel spacing of the modulated optical wavelength channels 25_{1,1} to 25_{M,N}.

Accordingly, the sum equals: 2/3 R² E_{LO}² r₂²(t), where R is the responsivity of the photodetectors, E_{LO} is the electric field intensity of the LO signal 34₁ to 34_{N}, and r₂ is optical intensity of one of the modulated optical wavelength channels 25_{1,1} to 25_{M,N}.

In any embodiment, either a 120° hybrid mixer 131 or a 90° hybrid mixer 31 followed by an electrical amplifier 141 or 41, respectively, sums the squares of the 4 outputs of the 90° hybrid mixer 31 or the 3 outputs of a 120° hybrid mixer 131.

Using a 120° optical hybrid mixer 131 or a 90° optical hybrid mixer 31 has the following advantages: (1) the amplitude of the received signal is amplified by the local oscillator signal 32₁ to 32_{N}, (2) if multiple signals impinge on the optical hybrid mixer 31 or 131, as long as the channel-to-channel frequency spacing of each signal is greater than the receiver optical-to-electrical bandwidth, then the mixing products from the out-of-band signals are effectively filtered out. Thus, the use of a LO signal 32₁ to 32_{N}, optical hybrid mixer 31 or 131, and sum-of-squares electrical amplifier 41 or 141 creates a very effective wavelength demultiplexer, (3) the use of the optical hybrid mixer 31 or 131 as a demultiplexer relaxes the demultiplexer requirements elsewhere in the silicon photonic circuits. For example, a first demultiplexer, e.g. 26_{1,1} to 26_{1,N} or 125, can be used to split the incoming WDM signal, e.g. 18₁, between multiple optical hybrid mixers 31 or 131. Then, the optical hybrid mixer/LO/sum-of-squares amplifier 41 or 141 act as a second filter. The design of a demultiplexer without regard for optical crosstalk is superior to a similar design with improved crosstalk.

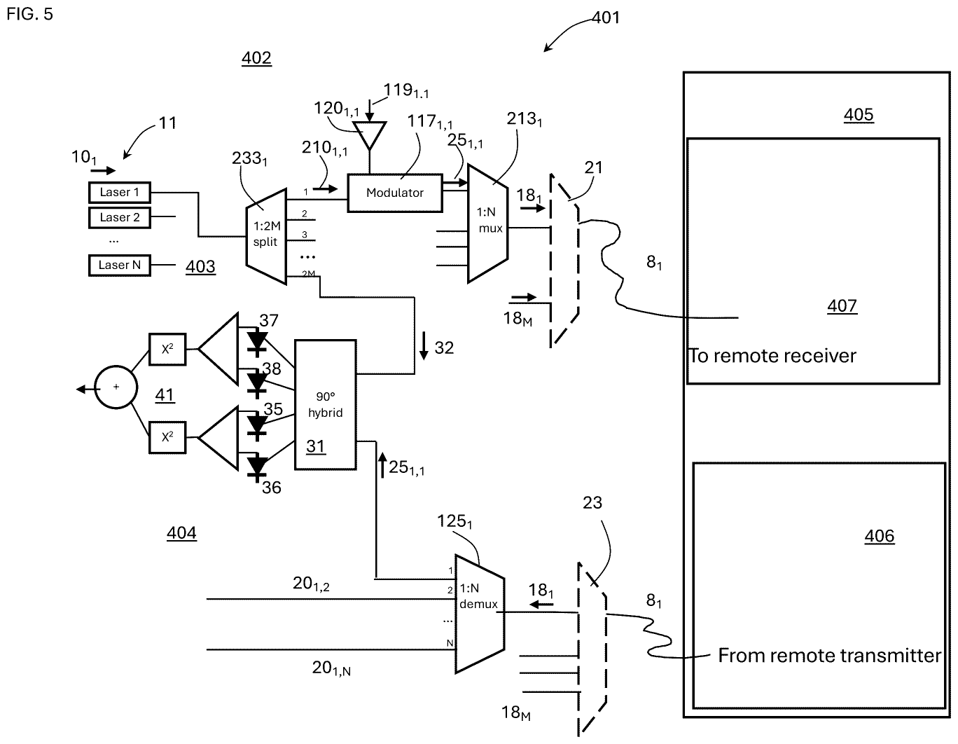

In other exemplary embodiments, illustrated in FIGS. 5 to 7, an optical link 401 includes a local transmitter/receiver 402, comprising a local transmitter 403 and a local receiver 404, and a remote transmitter/receiver 407 comprising a remote transmitter 406 and a remote receiver 407. In the local transmitter 403 and the remote transmitter 406. The light source 11, is configured for generating a plurality (N) of optical wavelength channels 10₁ to 10_{N} each with a different optical wavelength range, typically with channel spacings between wavelengths of 100 GHz, 200 GHz, 400 GHz, 800 GHz or 2000 GHz to provide at least N sub-ranges of wavelengths. Each laser is coupled to one or more splitters 233₁ to 233_{N}, e.g. 1×2M, configured for separating a respective one of plurality (N) of optical wavelength channels 10₁ to 10_{N} into a plurality of signal portions 210_{1,1}, to 210_{N,2M}. Half of the signal portions are transmitted via waveguides to a respective one of the optical hybrid mixers 31, as the LO signals 32₁ to 32_{N}, while the other half of the signal portions are transmitted via waveguides to a respective modulator 117_{1,1} to 117_{N,M}. Each modulator 117_{1,1} to 117_{N,M} modulates a respective one of the signal portions 210_{1,1} to 210_{N,M} at a different wavelength generating a plurality of modulated optical signals 25_{1,1} to 25_{N,M}. The modulated optical signals, e.g. 25_{1,1} to 25_{N,M}, from a respective laser are then multiplexed together using one of a plurality of multiplexers 213₁ to 213_{N} generating a plurality of multiplexed modulated optical signals 18₁ to 18_{N}. As above, an interleaver 21 and a deinterleaver 23 can be used to combine and separate all of the multiplexed modulated optical signals 18₁ to 18_{M} for transmission on a single optical fiber 8₁ or the interlever 21/deinterleaver 23 can be omitted, whereby each one of the multiplexed modulated optical signals 18₁ to 18_{M} can be transmitted on a different optical fiber 8₁ to 8_{M}. In this case, the modulators 117_{1,1} to 117_{N,M} do not need to be wavelength-dependent, since the additional wavelength filtering, i.e. the multiplexers 213₁ to 213_{N} and the demultiplexer 125₁ to 125_{N} creates this functionality.

For embodiments with an interleaver 21, the local receiver 404 and the remote receiver 407 include a deinterleaver 23 for separating the interleaved multiplexed modulated optical signals 18₁ to 18_{M} onto separate output waveguides 24 coupled to different demultiplexers 125₁ to 125_{M}. The local receiver 404 and the remote receiver 405 include a plurality of demultiplexers 125₁ to 125_{M} configured for demultiplexing the multiplexed modulated optical signals 18₁ to 18_{M}. Each demultiplexer 125₁ to 125_{M} has a plurality of outputs, e.g. M, which are each coupled to a 90° optical hybrid mixer 31 and amplifier 41, as hereinbefore described.

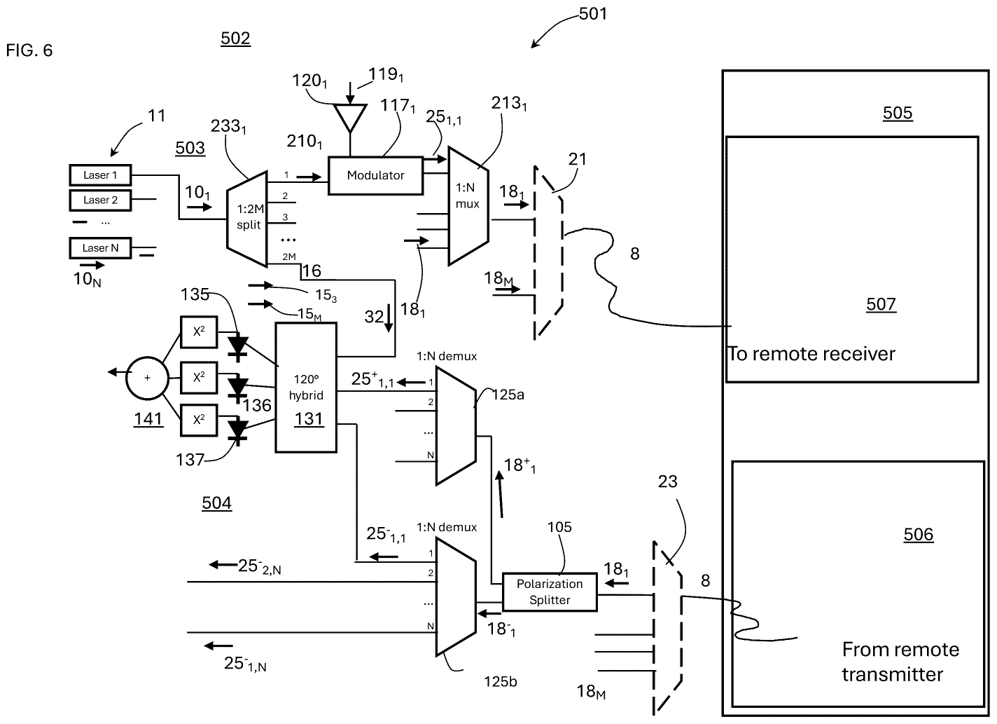

With reference to FIG. 6, a polarization independent optical link 501 includes a local transmitter/receiver 502 including a local transmitter 503 and a local receiver 504, and a remote transmitter/receiver 505 comprising a remote transmitter 506 and a remote receiver 507. The local transmitter 503 (and the remote transmitter 506) can be the same as the local transmitter 403 in previous example detailed above and illustrated in FIG. 5, However, the local receiver 504 and the remote receiver also include the polarization splitter 105 and the first demultiplexer 125a and the second demultiplexer 125b, along with the 120° optical hybrid mixer 131, as in the previous example detailed above and illustrated in FIG. 4.

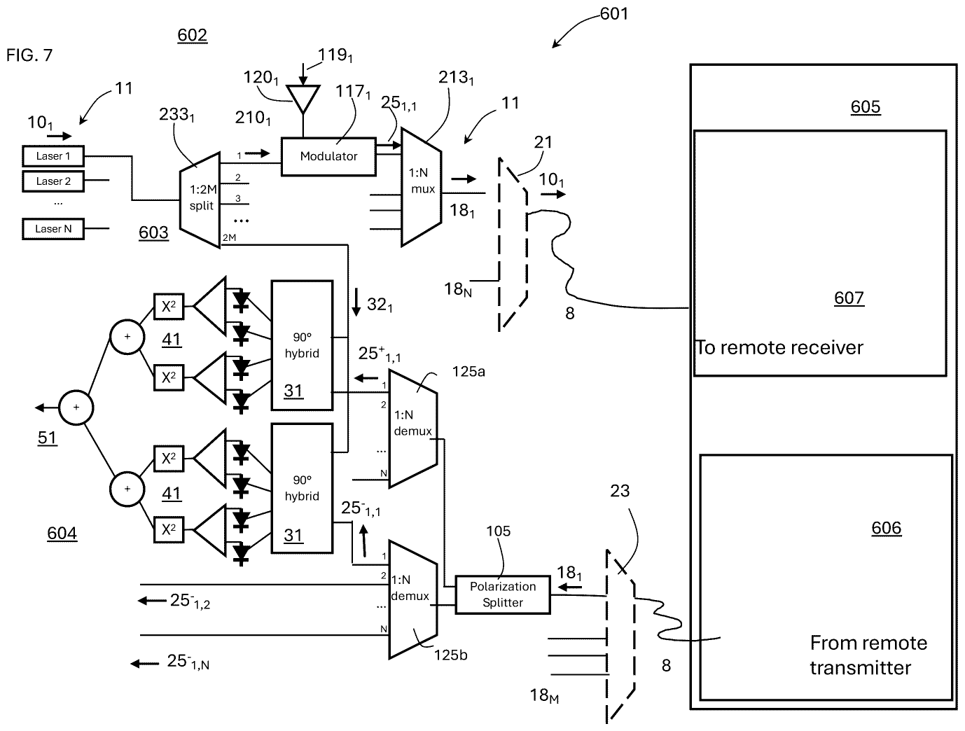

With reference to FIG. 7, polarization independent optical link 601 includes a local transmitter/receiver 602 including a local transmitter 603 and a local receiver 604, and a remote transmitter/receiver 605 comprising a remote transmitter 606 and a remote receiver 607. The local transmitter 603 (and the remote transmitter 606) can be the same as the local transmitter 403 or 503, as in previous examples detailed above and illustrated in FIGS. 5 and 6. However, the local receiver 604 and the remote receiver 607 also include the polarization splitter 105 and the first demultiplexer 125a and the second demultiplexer 125b, along with two 90° optical hybrid mixers 31, which are used in place of the 120° optical hybrid mixer 131 shown in FIG. 6. An additional sum 51 is performed of the outputs of the two sum-of-squares TIA amplifiers 41 in order to produce an output which will be independent of the input optical polarization state of the plurality of modulated optical wavelength channels 25.

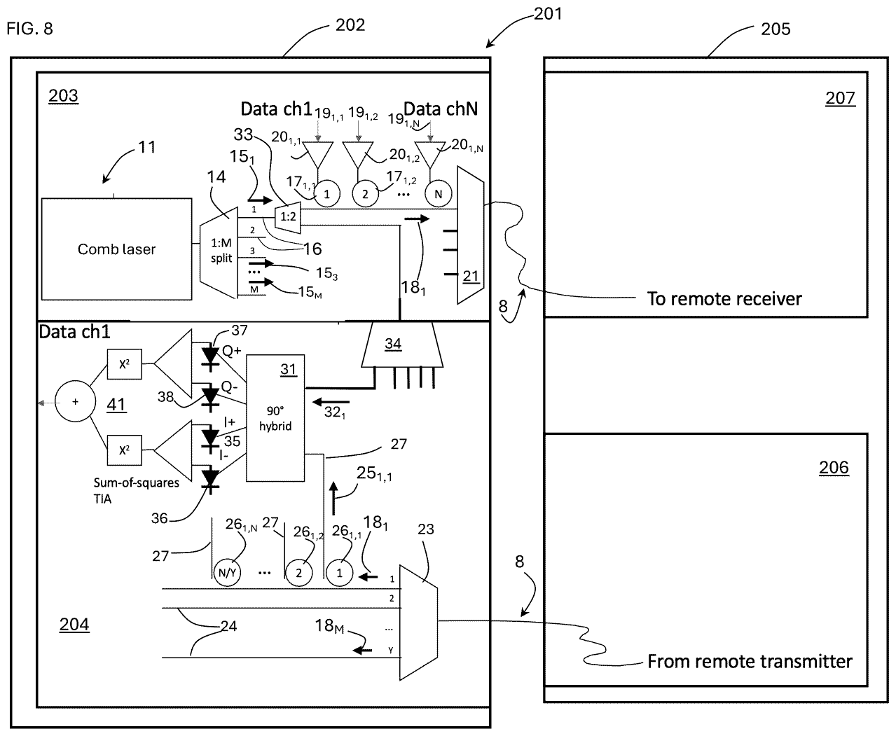

With reference to FIG. 8, in any of the aforementioned embodiments the light source 11 can comprises a comb laser with N wavelength comb lines. The comb laser light source 11 may be of several implementations, such as with a single pump laser source into a resonant cavity, wherein the optical properties of the resonant cavity exhibit a nonlinear dependence on input optical power.

The light source 11 may comprise an external fixed-wavelength laser with N wavelengths combined into one lane and split M-ways (N>=1, M>=1); an external fixed-wavelength laser with N wavelengths with multiplexing to occur on-chip; an external tunable-wavelength laser with N wavelengths combined into one lane and split M-ways (N>=1, M>=1); a comb laser with N wavelength comb lines as output; or an external tunable wavelength laser with N wavelengths with multiplexing to occur on-chip. Finally, in any of these cases, the light source 11 may be tunable. Tunability will alleviate the design of an on-chip demultiplexer for both the LO path as well as the signal path. It will also alleviate optical-to-electrical bandwidth requirements on the nonlinear sum-of-squares TIA.

The optical fibers 8₁ to 8_{M} may comprise a polarization-maintaining fiber, a standard single mode fiber (SMF) or a multi-core fiber.

The demultiplexers 34 or 125 may comprise deinterleavers; ring resonator add-drop; multi-ring add-drop filters; cascaded Mach-Zehnders filters; arrayed waveguide gratings; echelle gratings; thin-film filters of arbitrary order; or any combination of the above cascaded in series or parallel with one another.

The modulator 17 and 117, may comprise resonant modulators on a common bus (such as single-ring, double-ring, multi-ring, Fabry-Perot, coupling modulators, multi-segment ring coupling modulators, and more). These resonant modulators require that the laser sources are multiplexed prior to the modulator or modulators not on a common bus, which may be one of many possible types in literature, such as any resonant modulator, Mach-Zehnder modulator, dual-nested Mach-Zehnder, resonantly-assisted Mach-Zehnder (not necessarily single-rings), Michelson modulators, and more.

The foregoing description of one or more example embodiments has been presented for the purposes of illustration and description. It is not intended to be exhaustive or to limit the invention to the precise form disclosed. Many modifications and variations are possible in light of the above teaching. It is intended that the scope of the disclosure be limited not by this detailed description.

We claim:

1. An optical link comprising:
a local transmitter configured for generating a plurality of modulated optical wavelength channels (25), comprising:
one or more light sources configured for generating a plurality of input optical signals (10) with different wavelength channels;
a plurality of modulators for modulating the plurality of input optical signals forming the plurality of modulated optical wavelength channels (25);
one or more first splitters for generating first local oscillator signals from the plurality of input optical signals; and
one or more multiplexers disposed before or after the plurality of modulators, which in combination with the plurality of modulators is configured for generating a plurality of modulated multi-wavelength optical signals (18), each with a respective subset of the plurality of modulated optical wavelength channels (25); and
a remote receiver, comprising:
a plurality of demultiplexers, each demultiplexer configured for demultiplexing one of the plurality of modulated multi-wavelength optical signals (18) into the respective subset of the plurality of modulated optical wavelength channels (25);
a plurality of optical hybrid mixers, each optical hybrid mixer configured for mixing one of second local oscillator signals from a remote transmitter with one of the plurality of modulated optical wavelength channels (25) producing mixed optical signals ((I+ and I−) and (Q+ and Q−) or (I₁, I₂ and I₃));
a plurality of photodetectors for converting the mixed optical signals into electrical signals; and
an amplifier configured for summing squares ((I++I−)²+(Q++Q−)² or (I₁², I₂² and I₃²)) of the electrical signals.

2. The optical link according to claim 1, wherein the receiver is configured for cancelling frequency and phase differences between the second local oscillator signals and the plurality of modulated optical wavelength channels and/or suppressing interference from adjacent wavelength channels.

3. The optical link according to claim 1, wherein the receiver includes analog circuitry with an analog optical-to-electrical bandwidth greater than a bandwidth of each optical wavelength channel but smaller than an optical frequency spacing between adjacent modulated optical wavelength channels, whereby the receiver only transmits the electrical signals that correspond to the modulated optical wavelength channels with a wavelength closest to a wavelength of the second local oscillator signals.

4. The optical link according to claim 1, wherein the one or more multiplexers is disposed before the plurality of modulators for combining the plurality of input optical signals into a combined laser signal;
further comprising a second splitter for splitting the combined laser signal into a plurality of multi-wavelength signal portions; and
wherein the plurality of modulators comprises a plurality of sets of wavelength-dependent modulators, each one of the plurality of sets of wavelength-dependent modulators is configured for modulating a respective one of the plurality of multi-wavelength signal portions generating the respective subset of the plurality of modulated optical wavelength channels (25) and the respective one of the plurality of modulated multi-wavelength optical signals (18).

5. The optical link according to claim 1, wherein the one or more first splitters comprises a plurality of LO splitters (233), each of the plurality of LO splitters (233) configured for splitting a respective one of the input optical signals into a plurality (2M) of optical signal portions, a first half of the plurality of optical signal portions forming the first local oscillator signals, and a second half of the plurality of optical signal portions transmitted to the plurality of modulators; and
wherein each one of the plurality of modulators receives one of the second half of the plurality of optical signal portions for generating a corresponding one of the plurality of modulated optical wavelength channels (25);
wherein the one or more multiplexers comprises a plurality of multiplexers (213), one of the plurality of multiplexers corresponding to each one of the plurality of LO splitters (233) configured for combining the respective subset of the plurality of modulated optical wavelength channels (25) into a respective one of the plurality of multi-wavelength optical signals (18).

6. The optical link according to claim 1, wherein the local transmitter further comprises an interleaver configured for combining the plurality of modulated multi-wavelength optical signals onto a single optical fiber; and
wherein the remote receiver further comprises a deinterleaver configured for separating the modulated multi-wavelength optical signals onto different waveguides for transmission to a different one of the plurality of demultiplexer.

7. The optical link according to claim 4, wherein the one or more first splitters comprises a plurality of first splitters, each one of the plurality of first splitters coupled between the light source and the multiplexer.

8. The optical link according to claim 4, wherein the one or more first splitters comprises a first splitter coupled between the second splitter and the plurality of modulators.

9. The optical link according to claim 1, wherein the plurality of modulators comprises a plurality of wavelength dependent modulators.

10. The optical link according to claim 1, wherein the plurality of demultiplexers comprises a plurality of wavelength dependent optical filters.

11. The optical link according to claim 1, wherein each one of the plurality of optical hybrid mixers comprises a 90° optical hybrid mixer configured for mixing one of the second local oscillator signals with one of the modulated optical wavelength channels producing in-phase (I+ and I−) and quadrature (Q+ and Q−) electrical signals; and
wherein the amplifier is configured for summing squares ((I++I−)²+(Q++Q−)²) of the in-phase and quadrature electrical signals.

12. The optical link according to claim 1, wherein the remote receiver also comprises one or more polarization splitters configured for splitting each of the plurality of modulated multi-wavelength optical signals (18) into a respective first orthogonally polarized receiver signal portion and a respective second orthogonally polarized receiver signal portion;
wherein the plurality of demultiplexers comprises a plurality of first demultiplexers configured for demultiplexing the respective first orthogonally polarized receiver signal portion into first polarized portions of the plurality of modulated optical wavelength channels, and a plurality of second demultiplexers configured for demultiplexing the respective second orthogonally polarized receiver signal portions into second polarized portions of the plurality of modulated optical wavelength channels;
wherein each one of the plurality of optical hybrid mixers comprises a 120° optical hybrid mixer configured for receiving one of the first polarized portions of the plurality of modulated optical wavelength channels, one of the second polarized portions of the plurality of modulated optical wavelength channels, and one of the second local oscillator signals generating a first photodetector current, a second photodetector current, and a third photodetector current; and
wherein each 120° optical hybrid mixer is configured for adding the squares of first photodetector current, second photodetector current and third photodetector current.

13. An optical device comprising:
a local transmitter configured for generating a first plurality of modulated optical wavelength channels (25), comprising:
one or more light sources configured for generating a first plurality of input optical signals (10) with different wavelength channels;
a plurality of modulators for modulating the first plurality of input optical signals (10) forming the first plurality of modulated optical wavelength channels (25);
one or more first splitters for generating first local oscillator signals from the first plurality of input optical signals; and
one or more multiplexers disposed before or after the plurality of modulators, which in combination with the plurality of modulators is configured for generating a first plurality of modulated multi-wavelength optical signals (18), each with a respective subset of the first plurality of modulated optical wavelength channels (25); and
a local receiver, comprising:
a plurality of demultiplexers, each demultiplexer configured for demultiplexing one of a second plurality of modulated multi-wavelength optical signals (18) from a remote transmitter into a respective subset of a second plurality of modulated optical wavelength channels (25);
a plurality of optical hybrid mixers, each optical hybrid mixer configured for mixing one of the first local oscillator signals with one of the second plurality of modulated optical wavelength channels producing mixed optical signals ((I+ and I−) and (Q+ and Q−) or I1, I2 and I3);
a plurality of photodetectors for converting the mixed optical signals into electrical signals;
an amplifier configured for summing squares ((I++I−)²+(Q++Q−)² or (I₁², I₂² and I₃²)) of the electrical signals.

14. The optical device according to claim 13, wherein the local receiver is configured for cancelling frequency and phase differences between the first local oscillator signals and the second plurality of modulated optical wavelength channels and/or suppressing interference from adjacent wavelength channels.

15. The optical device according to claim 13, wherein the local receiver includes analog circuitry with an analog optical-to-electrical bandwidth greater than a bandwidth of each of the second plurality of modulated optical wavelength channels but smaller than an optical frequency spacing between adjacent ones of the second plurality of modulated optical wavelength channels, whereby the local receiver transmits only electrical signals that correspond to the second modulated optical wavelength channels with a wavelength closest to a wavelength of the first local oscillator signals.

16. The optical device according to claim 13, wherein the one or more multiplexers is disposed before the plurality of modulators for combining the first plurality of input optical signals into a combined laser signal;
further comprising a second splitter for splitting the combined laser signal into a plurality of multi-wavelength signal portions; and
wherein the plurality of modulators comprises a plurality of sets of wavelength-dependent modulators, each one of the plurality of sets of wavelength-dependent modulators is configured for modulating a respective one of the plurality of multi-wavelength signal portions generating the respective subset of the first plurality of modulated optical wavelength channels (25) and the respective one of the first plurality of modulated multi-wavelength optical signals (18).

17. The optical device according to claim 13, wherein the one or more first splitters comprises a plurality of first splitters, each one of the plurality of first splitters coupled between the light source and the multiplexer.

18. The optical device according to claim 13, wherein the plurality of modulators comprises a plurality of wavelength dependent modulators; and wherein the plurality of demultiplexers comprises a plurality of wavelength dependent optical filters.

19. The optical device according to claim 13, wherein each one of the plurality of optical hybrid mixers comprises a 90° optical hybrid mixer configured for mixing one of the second local oscillator signals with one of the modulated optical wavelength channels producing in-phase (I+ and I−) and quadrature (Q+ and Q−) electrical signals; and
wherein the amplifier is configured for summing squares ((I++I−)²+(Q++Q−)²⁾ of the in-phase and quadrature electrical signals.

20. The optical device according to claim 13, wherein the local receiver includes one or more polarization splitters configured for splitting each of the second plurality of modulated multi-wavelength optical signals (18) into a respective first orthogonally polarized receiver signal portion and a respective second orthogonally polarized receiver signal portion;
wherein the plurality of demultiplexers comprises a plurality of first demultiplexers configured for demultiplexing the respective first orthogonally polarized receiver signal portion into first polarized portions of the second plurality of modulated optical wavelength channels, and a plurality of second demultiplexers configured for demultiplexing the respective second orthogonally polarized receiver signal portions into second polarized portions of the second plurality of modulated optical wavelength channels;
wherein each one of the plurality of optical hybrid mixers comprises a 120° optical hybrid mixer configured for receiving one of the first polarized portions of the second plurality of modulated optical wavelength channels, one of the second polarized portions of the second plurality of modulated optical wavelength channels, and one of the second local oscillator signals generating a first photodetector current, a second photodetector current, and a third photodetector current; and
wherein each 120° optical hybrid mixer is configured for adding the squares of first photodetector current, second photodetector current and third photodetector current.
